(19) United States
(12) Patent Application Publication
(10) Pub. No.: US 2007/0059520 A1
(43) Pub. Date: Mar. 15, 2007

(54) Method and article for mounting a touch screen

(76) Inventors: Paul M. Hatin, Londonberry, NH (US); Manuel J. Palomino, Malden, MA (US); Roger T. Hager, Woodbury, MN (US)

Correspondence Address: 3M INNOVATIVE PROPERTIES COMPANY, PO BOX 33427, ST. PAUL, MN, 55133-3427, US

(21) Appl. No.: 11/225,558

(22) Filed: Sep. 13, 2005

(51) Int. Cl. B32B 7/12

(52) U.S. Cl. 428/343

(57) ABSTRACT

A method of removably mounting a touch screen assembly, including a glass substrate-based touch screen, to a display panel assembly of a touch screen display system. The method includes providing at least one double-sided, stretch releasable adhesive strip and adhering the strip to the touch screen and the display panel assembly to attach the touch screen to the display panel assembly. The strip is stretch releasable from the screen and the panel assembly to facilitate removal of the touch screen. In one embodiment, the strip includes an adhesive segment defining a longitudinal axis and a non-tacky pull tab extending from the adhesive segment in an angular fashion relative to the longitudinal axis.

### BACKGROUND

The present invention relates generally to mounting of glass substrate-based objects. More particularly, it relates to mounting a glass substrate-based object to a surface of a separate object, such as mounting a touch screen to a display panel assembly, in a manner affording simplified removal, along with adhesive articles adapted to facilitate such mounting.

Touch screen display systems are used in a wide variety of environments. For example, touch screen display systems are used as the input and display interface for automatic teller machines, gaming machines in casinos, self-service kiosks (such as airline boarding pass kiosks, vending machines, etc.), and cash registers, to name but a few.

In general terms, a touch screen display system includes a touch screen assembly and a display assembly. A touch screen and connective circuitry (e.g., Kapton flexible circuitry) are typically provided with the touch screen assembly, whereas the display assembly includes a display panel and a computing device (e.g., a computer having a micro-processor). The touch screen is assembled over the display panel, and the connective circuitry is electronically coupled to the computing device. The computing device, in turn, drives the images displayed on the display panel, such as an LCD, in either a variable or fixed format. These images are viewable by a user through the touch screen, whom then interacts with the touch screen to perform a desired activity.

More particularly, the touch screen generally comprises an insulative (e.g., glass) substrate and a resistive layer disposed on the insulative substrate. A pattern of conductive edge electrodes is formed on the edges of the resistive layer. This configuration allows the touch screen to effectively “sense” or recognize the existence and location of a “touch” on its exterior surface (e.g., user's finger, stylus, etc.). The sensed location of the touch is signaled to the computing device via the connective circuitry. The computing device, in turn, correlates the sensed touch location with the image(s) displayed (or caused to be displayed) on the display panel. This correlation can then be interpreted as a user command, dictating further operations by the computing device. For example, the displayed images can include a question being posed to the user, along with a “yes” icon and a “no” icon; where the sensed touch location corresponds with a display panel location of the “yes” icon, the computing device can determine that the user has responded affirmatively to the posed question and thus proceed forward with a particular operation in accordance with this user command.

Vast improvements have been made in both touch screen and display assembly technology. For example, newer software is constantly being developed to facilitate use of touch screen display systems in different industries and to address user friendliness concerns. Also, marked advancements in touch screen sensitivity and durability have been recognized. However, the technique by which the touch screen is mounted to the display panel has essentially remained unchanged and may be less than optimal.

As a point of reference, the touch screen assembly is normally manufactured apart from the display assembly and subsequently mounted thereto. In this way, a “universal” touch screen assembly (in terms of touch screen's outer dimensions) can be provided for use with a variety of different display assembly platforms. Further, when necessary, the touch screen assembly can be removed from the display assembly for replacement, accessing inner components of the display assembly, etc.

With the above in mind, mounting of the touch screen assembly to the display assembly includes electronically coupling the connective circuitry to the computing device, and securing the touch screen over the display panel. The display panel is normally encased within an outer frame; due to variations in display panel platforms, mechanical mounting device(s) (e.g., screws or bolts) are normally not available for attaching the touch screen. Instead, pieces of conventional, permanent-bonding, double-sided gasket tape (such as, for example, double-sided gasket tape available from 3M Company of St. Paul, Minn. under the trade designation Double Coated Vinyl Foam Tape 4408 or 4416) are employed to adhere the touch screen to the outer frame. Permanent-bonding, double-sided gasket tape is the universally accepted product for touch screen mounting in light of its ability to maintain adhesive stability (and thus attachment of the touch screen to the display panel frame) under the wide ranging environmental conditions that the touch screen display system is likely subjected (e.g., temperatures in excess of 125 degrees F., temperatures below 15 degrees F., and relative humidity greater than 70% RH).

While quite viable as an attachment article, double-sided gasket tape renders subsequent removal of the touch screen from the display panel frame quite difficult. The strong adhesive properties of permanent-boding gasket tape make it impossible to simply pull the touch screen off of the display panel frame. Instead, a cutting tool (e.g., knife, box cutter, etc.) must be used to cut through the tape. The sharp surface associated with these cutting tools can easily damage the touch screen and/or the display panel, and presents a possibility of operator harm. In light of these concerns, operators must take great care when cutting the gasket tape, thus increasing the time and skill required to remove the touch screen. Further, once the gasket tape has been cut and the touch screen removed, adhesive residue (and even portions of the tape substrate) remains on both the touch screen and the display panel frame. This adhesive residue must be removed from the display panel frame (and possibly from the touch screen as well), which typically entails use of a removal agent (e.g., isopropyl alcohol), the operator's fingers and a wipe of some type. In short, removing the gasket tape residue is a messy, time-consuming task.

Permanent-bonding, double-sided gasket tape, though able to satisfy the rigorous environmental conditions in which touch screen display systems are often operated, presents certain problems associated with removal of the touch screen. Workers skilled in the art will recognize that similar concerns arise in other areas in which a glass substrate-based body (e.g., vandal-proof glass or privacy glass) is removably mounted to a separate structure (e.g., a display, bezel, or chassis). Therefore, a need exists for a method and related articles for mounting a touch screen (or other glass substrate-based body) to a display panel (or other structure) using an adhesive article in manner facilitating straightforward, mess-free removal of the touch screen from the display panel.

### SUMMARY

Principles of the present invention overcome the above-identified limitations in the field by providing a method, system and article for removably mounting a touch screen to a display panel assembly in a manner affording easy, mess-free removal, as well as maintaining adhesive integrity under rigorous environmental conditions.

Aspects in accordance with principles of the present invention relate to a method of removably mounting a touch screen assembly to a display panel assembly. The touch screen assembly includes a touch screen. With this in mind, at least one double-sided, stretch releasable adhesive strip is provided. The strip is adhered to the touch screen and the display panel assembly to attach the touch screen to the display panel assembly. To this end, the strip is releasable from the touch screen and the display panel assembly via a stretch release operation to facilitate removal of the touch screen from the display panel assembly. In one embodiment, a plurality of similarly-sized strips are provided, with each strip including a non-tacky pull tab extending from an adhesive segment in an angular fashion relative to a longitudinal axis defined by the adhesive segment. With this one embodiment, the method further includes cutting at least one of the strips to a desired length such that two or more of the strips are applied relative to a perimeter edge of the touch screen so as to encompass virtually an entirety of a length of the perimeter edge, and each of the respective pull tabs project outwardly from the perimeter edge.

Other aspects in accordance with the principles of the present invention relate to a touch screen system for use as part of a touch screen display system including a display assembly. The touch screen system includes a touch screen assembly and at least one double-sided, stretch releasable adhesive strip. The touch screen assembly includes a glass substrate-based touch screen and connective circuitry extending from the touch screen. The double-sided, stretch releasable strip is configured to removably mount the touch screen to the display assembly. In one embodiment, a plurality of strips is provided, each of the strips being configured to exhibit a 180° peel strength on a glass substrate at 98% relative humidity of at least about 5.47 N/dm.

Yet other aspects in accordance with principles of the present invention relate to a kit for mounting a glass substrate-based touch screen to a display panel assembly of a touch screen display system. The kit includes a plurality of strips of double-sided, stretch releasable adhesive. In one embodiment, the kit further includes an instruction manual outlining instructions on how to use the plurality of strips to removably mount a touch screen to a display panel assembly. In another embodiment, each of the strips includes an adhesive segment defining a longitudinal axis and a non-tacky pull tab extending in an angular fashion from the adhesive segment relative to the longitudinal axis.

Yet other aspects in accordance with principles of the present invention relate to a double-sided, stretch releasable adhesive strip for mounting a first object to a second object. The strip includes an adhesive segment and a non-tacky pull tab extending from the adhesive segment. More particularly, the pull tab extends in an angular fashion relative to a longitudinal axis defined by the adhesive segment. In one embodiment, extension of the pull tab defines an extension axis, with the extension axis and the longitudinal axis combining to define an extension angle of less than 170° and, in some embodiments, greater than 90°.

### BRIEF DESCRIPTION OF THE DRAWINGS

FIG. 1 is a block diagram of a touch screen display system including an adhesive mounting article in accordance with principles of the present invention;

FIG. 2A is a schematic top view of a typical touch screen assembly;

FIG. 2B is a side view of a portion of a touch screen of the assembly of FIG. 2A;

FIG. 3A is top plan view of a double-sided, stretch releasable adhesive strip used as the adhesive mounting article of FIG. 1;

FIG. 3B is a longitudinal, cross-sectional view of the strip of FIG. 3A;

FIG. 4A is a rear plan view of the touch screen of FIG. 2B including strips applied thereto as part of a method of removably mounting a touch screen to a display panel assembly in accordance with principles of the present invention;

FIG. 4B is a side view of a portion of the touch screen and strips of FIG. 4A assembled to a display panel assembly;

FIG. 4C is a sectional side view illustrating removal of the touch screen from the display panel assembly, including the strip being partially stretched;

FIG. 5 is a rear plan view of the touch screen of FIG. 2B including strips applied thereto in accordance with other embodiments;

FIG. 6 is a top plan view of another embodiment double-sided, stretch releasable strip in accordance with principles of the present invention; and

FIG. 7 is a rear plan view of the touch screen of FIG. 2B including a plurality of the strips of FIG. 6 applied thereto in connection with methods of the present invention.

### DETAILED DESCRIPTION

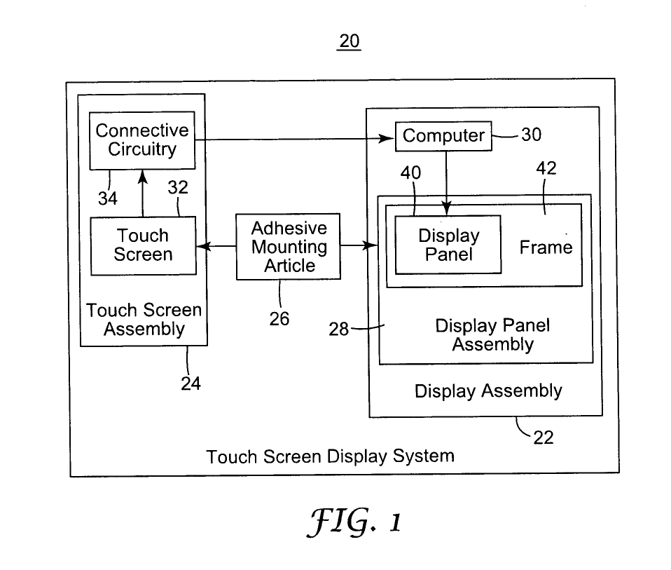

Aspects of the present invention relate to methods of removably mounting a touch screen to a display panel assembly in forming a touch screen display assembly via an adhesive mounting article in accordance with principles of the present invention. By way of reference, FIG. 1 illustrates in block form various components of a touch screen display system 20, many of which are known in the art and thus described in general terms below. The touch screen display system 20 includes a display assembly 22, a touch screen assembly 24 and an adhesive mounting article 26. The display assembly 22 includes a display panel assembly 28 and a computer 30. The touch screen assembly 24 includes a touch screen 32 and connective circuitry 34. The connective circuitry 34 is electronically coupled to the computer 30 that in turn is electronically coupled to the display panel assembly 28. The touch screen 32 is removably mounted to the display panel assembly 28 with the adhesive mounting article 26. As described in greater detail below, the adhesive mounting article 26 is adapted to withstand the rigorous environmental conditions possibly experienced by the touch screen display assembly 20, yet can be readily detached from the display panel assembly 28 and the touch screen 32, leaving behind virtually no adhesive/substrate residue.

The display assembly 22 is of a type known in the art, and can assume a wide variety of forms. In general terms, the display panel assembly 28 includes a display panel 40 housed within a frame or chassis 42. The display panel 40 can be of any format acceptable for displaying images as part of touch screen display system, such as a liquid crystal display (LCD), cathode ray tube (CRT), plasma display, electroluminescent (EL) display, etc. Regardless, images displayed by the display panel 40 are driven by the computer or computing device 30 that also can assume a variety of forms. The computer 30 generally includes a micro-processor (not shown) performing operations dictated by associated programming/software adapted to effectuate user interface in completing a desired objective (e.g., arcade game, casino gaming, cash register, self-serve product purchase, generating airline boarding passes, handheld organizer, PDA, etc.). Regardless of exact form, the frame 42 encompasses a border of the display panel 40 as well as the computer 30, although in alternative embodiments the computer 30 can be housed apart from the display panel 40 and/or the frame 42 need not extend about the border of the display panel 40.

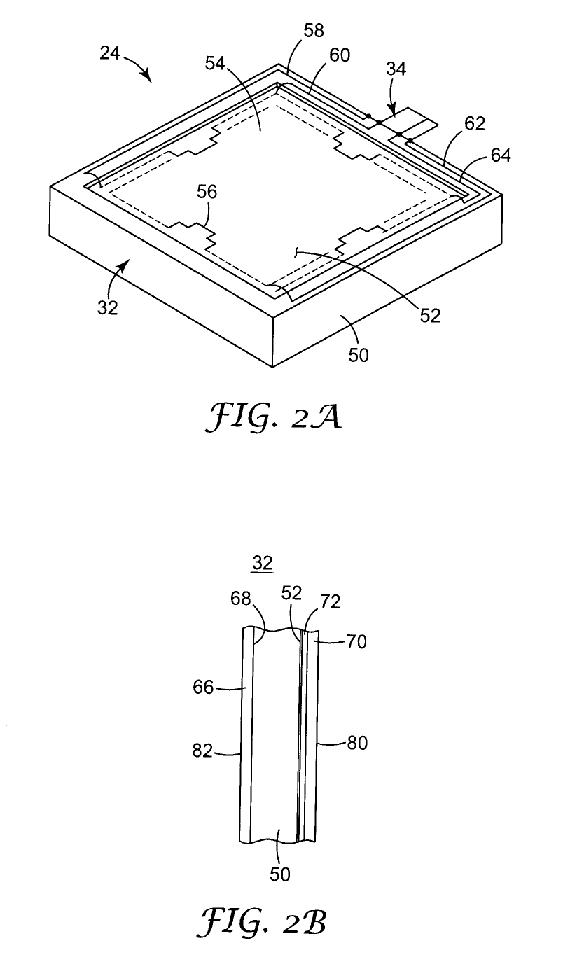

The touch screen assembly 24, including the touch screen 32 and the connective circuitry 34, is also of a type known in the art. In basic terms, and with reference to FIG. 2A, in one embodiment the touch screen 32 can be of an analog or digitizing type, and includes an insulative glass substrate 50 coated on a major surface 52 with a resistive layer 54 (referenced generally). A conductive edge electrode pattern 56 and wire traces, for example wire traces 58-64 are formed on a periphery of the glass substrate 50, such as by printing a thick-film conductive material (e.g., a conductive silver/frit paste). The touch screen 32 can further include other layers/coatings. For example, and with additional reference to FIG. 2B, a protective coating(s) 66 can be applied over a second major surface 68 of the glass substrate 50; similarly or alternatively, a protective coating(s) 70 (such as a coating adapted to promote sliding of a user's finger) can be applied over the edge electrode pattern 56/wire traces 58-64 (best shown in FIG. 2A; referenced collectively in FIG. 2B as a conductive layer 72).

As will be understood by one of ordinary skill, various edge electrode patterns 56 are available, described for example in U.S. Pat. Nos. 4,198,539; 4,293,734; 4,371,746; and 6,549,193, the teachings of all of which are incorporated herein by reference. Similarly, a wide variety of techniques are available for forming/depositing the edge electrodes 56 and/or wire traces 58-64, described for example in U.S. Pat. No. 6,727,895 and U.S. Publication No. 2001/0028343, the teachings of both of which are incorporated herein by reference. Further, the coatings(s) 66 and/or 70 can also assume any desirable form, and can alternatively be eliminated. Stated more generally, the touch screen 32 can assume any form currently known or in the future created for use as part of the touch screen display assembly 20 (FIG. 1). Other exemplary embodiments of acceptable configurations for the touch screen 32 are provided in the previously-noted references, as well as in U.S. Pat. Nos. 6,587,097; 6,841,225; and 6,842,171, the teachings of all of which are incorporated herein by reference. Commercially-available examples of acceptable embodiments of the touch screen 32 include MicroTouch™ ClearTek™ and ClearTek™ II capacitive touch sensors, available from 3M Touch Systems, Inc. of Methuen, Mass., to name but a few. Regardless, the touch panel 28 defines first and second opposing major faces 80, 82, with the first major face 80 serving as the user interface/touch face.

Returning to FIG. 2A, the connective circuitry 34 can also assume any form currently known or in the future developed. The connective circuitry 34 is conventionally referred to as a “tail”, and is adapted for electronic connection to the computer or computing device 30 (FIG. 1) associated with the display assembly 22 (FIG. 1) or other accessory such as external decoding circuitry. The connective circuitry 34 is typically flexible (e.g., Kapton flex circuitry) and terminates in a plug or similar body (not shown) adapted to mate with a corresponding receptacle or port provided by the computer 30.

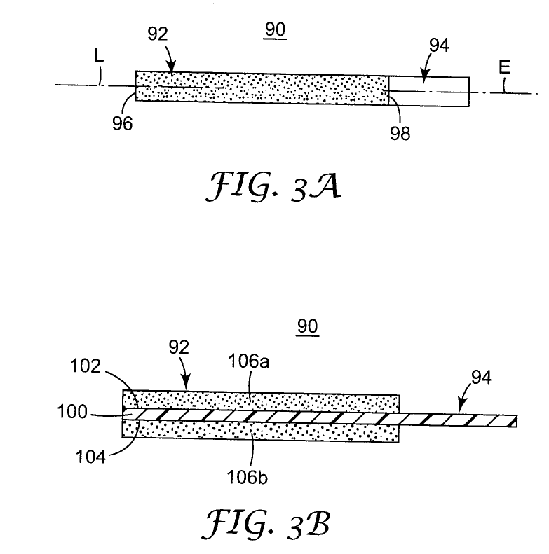

With the above general background of the display assembly 22 and the touch screen assembly 24 in mind, and returning to FIG. 1, the adhesive mounting article 26 in accordance with principles of the present invention includes one or more double-sided, stretch releasable adhesive strips. One embodiment of an acceptable double-sided, stretch releasable adhesive strip 90 is shown in FIG. 3A. The strip 90 is generally formed as a stretch releasing pressure sensitive adhesive tape that defines an exposed adhesive segment (or “adhesive segment”) 92 and a non-tacky pull tab segment (or “pull tab”) 94. As best shown in FIG. 3A, the adhesive segment 92 extends between a leading end 96 and a trailing end 98 to define a longitudinal axis L. The pull tab 94 extends from the trailing end 98 in a manner defining an extension axis E. In the one embodiment of FIG. 3A, the extension axis E is co-linear with the longitudinal axis L. In other embodiments (and as described in greater detail below), the pull tab 94 extends from the adhesive segment in an angular fashion such that the extension axis E is angularly off-set from the longitudinal axis L.

With additional reference to FIG. 3B, in one embodiment, the strip 90 includes a backing 100 defining first and second faces 102, 104, along with a stretch releasing pressure sensitive adhesive composition 106a, 106b coated over the faces 102, 104, respectively, to form the adhesive segment 92. With this one configuration, the pull tab 94 is defined by an absence of the stretch releasing adhesive composition 106a, 106b over the backing 100; in other words, the backing 100 is exposed along the pull tab 94. Alternatively, in other embodiments, the stretch releasing adhesive composition 106a, 106b encompasses substantially all of the respective faces 102, 104 of the backing 100, with the strip 90 further including a material layers (not shown) having a non-tacky exterior surface applied over the stretch releasing composition 106a, 106b in the region of the pull tab 94. Even further, and in other embodiments, the internal backing 100 can be eliminated and a single layer of stretch releasing adhesive composition provided; with this configuration, one or more material layer(s) having a non-tacky exterior surface are applied over the stretch releasing adhesive composition to define the pull tab 94.

Regardless of exact form, the double-sided, stretch releasable strip 90 is capable of forming a bond with a glass substrate-based body and maintaining adhesion to the body in high or low temperature, high humidity environments. The stretch releasing adhesive compositions 106a, 106b may or may not be identical, but are both formulated to exhibit a desired 180° peel strength to a glass substrate at a relative humidity above 80% RH and temperatures above 125° F. (52° C.) or below 15° F. (−9° C.); more preferably at a relative humidity equal to or above 90% RH and temperatures above 140° F. (60° C.) or below −40° F. (−40° C.). Alternatively, the strip 90 exhibits a 180° peel strength on a glass substrate at 98% RH of at least 5.47 N/dm. As a point of reference, these temperature/humidity requirements are typically viewed as standards when evaluating sufficiency of attachment between a touch screen and a display panel assembly as they reflect the extreme environmental conditions the touch screen display system may be exposed to.

In addition, the double-sided, stretch releasable adhesive strip 90 is extensible, stretchable and cleanly removable (i.e., does not leave a visible residue) from a variety of substrates such as glass, metal, etc. The strip 90, after having been bonded to a substrate, is also capable of being removed from the substrate without damaging the substrate. In general terms, the strip 90 is “stretch releasable” or “stretch removable” as it is capable of being removed from a substrate by applying a longitudinal pulling force (e.g., at a pull angle of less than approximately 45°) on to the pull tab 94. When sufficient force is applied to overcome the relatively high initial resistance to shearing stress otherwise exhibited by the strip 90, the backing 100 begins to deform. As the pulling force is continued (e.g., at a rate of approximately 30 cm/minute), the backing 100 yields (e.g., stretches) while the adhesive composition 106a, 106b releases from the surface to which the strip 90 has been applied. Once removed, the strip 90 does not leave a significant residue, preferably that which is visible to the unaided human eye, on the substrate to which was previously applied.

The backing 100 can include a single layer and multi-layer construction. Useful backings included, e.g., a polymeric foam layer, a polymeric film layer, and combinations thereof. Suitable polymeric backing materials, including polymeric foams and polymeric films, as well as other optional additives (e.g., an elastomeric additive) are described in U.S. Pat. No. 6,569,521, the teachings of which are incorporated herein by reference.

The stretch releasing adhesive compositions 106a, 106b are preferably identical, but may vary in terms of adhesive strength. Regardless, examples of suitable stretch releasing adhesive compositions include silicone-based pressure sensitive adhesive compositions. Useful silicone-based pressure sensitive compositions include a MQ tackifying resin and the silicone polymer can be present in the form of, e.g., a blend of MQ tackifying resin and silicone polymer, a reaction product of MQ tackifying resin and silicone polymer, e.g., a condensation cure or addition cure type reaction product, or a mixture thereof. Useful MQ tackifying resins include, e.g., MQ silicone resins, MQD silicone resins, and MQT silicone resins, which also may be referred to as copolymeric silicone resins and which preferably have a number average molecular weight of about 100 to about 50,000, more preferably about 500 to about 20,000 and generally have methyl substitutes. One example of a useful class of silicone polymers is silicone polyurea block copolymers. Silicone polyurea block copolymers include the reaction product of a polydiorganosiloxane diamine (also referred to as silicone diamine), a diisocyanate, and optionally an organic polyamine.

Various acceptable embodiments of the stretch releasing adhesive compositions 106a, 106b are described in greater detail in U.S. Pat. No. 6,596,521, the teachings of which are incorporated herein by reference. The '521 Patent provides adhesive compositions, as well as resultant stretch releasing adhesive tapes, useful as the strip 90 of the present invention. Other examples of acceptable constructions for the strip 90 are generally available under the trade name COMMAND II™ from 3M Company of St. Paul, Minn. Alternatively, other stretch release adhesive tape compositions configured to maintain adhesive integrity under the rigorous conditions outlined above may also be employed.

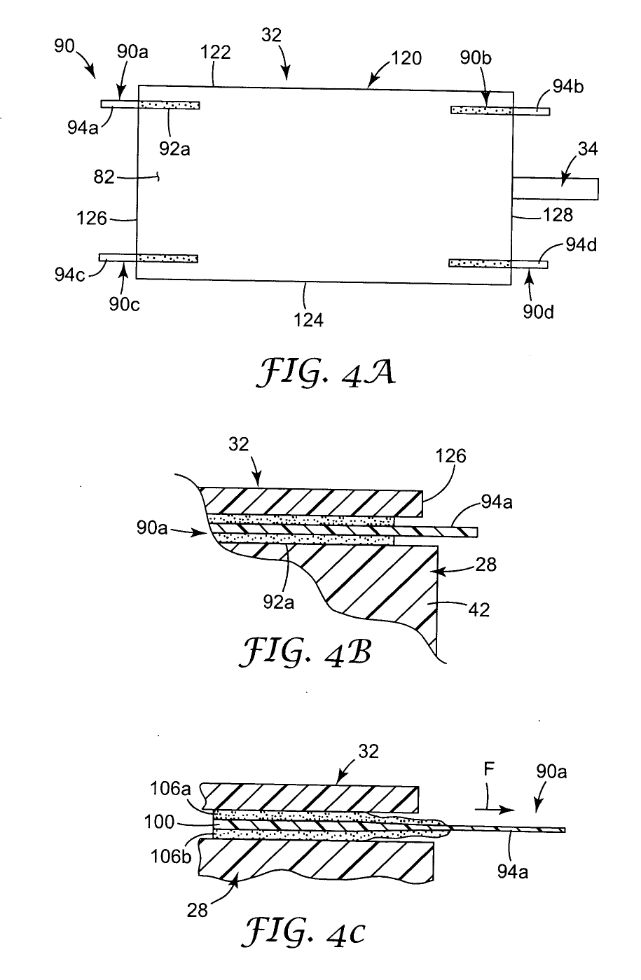

Regardless of an exact configuration, the double-sided, stretch releasable adhesive strip 90 is used to releasably mount a touch screen 32 (FIG. 1) to a display panel assembly 28 (FIG. 1) pursuant to methods in accordance with principles of the present invention. As previously described, in some touch screen display system configurations, the touch screen assembly 24 (FIG. 1), and thus the touch screen 32, is initially provided to a user apart from the display panel assembly 28. With this in mind, FIG. 4A schematically illustrates the touch screen 32 when viewed from the second major face 82 (it being recalled that the opposing, first major face 80 (FIG. 2B) serves as the user interface/touch face). The face 82 forms a perimeter 120 (referenced generally) defined by opposing, first and second side edges 122, 124 and opposing, first and second end edges 126, 128.

With the above designations in mind, one method of removably mounting the touch screen 32 to the display panel assembly 28 (FIG. 1) includes providing a plurality of the strips 90 (referenced generally) and adhering each of the plurality of strips along at least a portion of the second major face 82 of the touch screen 32. In particular, with the one embodiment of FIG. 4A, four of the strips 90a-90d are provided. The first strip 90a is positioned to extend adjacent to and substantially parallel with the first side edge 122. For purposes of illustration, the first strip 90a is shown as being laterally spaced from the first side edge 122, although in alternative embodiments, the first strip 90a contacts or encompasses the first side edge 122. Further, the phrase “substantially parallel” is in reference to the first strip 90a approximating a linear plane of the first side edge 122; however, the first strip 90a can deviate from a true parallel relationship (e.g., 10° from a true parallel relationship) as will typically be found where the first strip 90a is manually applied to the second major face 82 by a user. Regardless, the adhesive segment 92a is in contact with the second major face 82, and the first strip 90a is positioned such that at least a portion, preferably an approximate entirety, of the pull tab 94a extends outwardly from the first end edge 126, and thus from the perimeter 120. With this one technique, and as described in greater detail below, the pull tab 94a is readily available for grasping by a user in performing a stretch release operation.

The second, third and fourth strips 90b-90d are similarly adhered to the second major face 82. For example, the second strip 90b is positioned adjacent to, and extends substantially parallel with, the first side edge 122, with at least a portion of the corresponding pull tab 94b extending outwardly from the second end edge 128. The third strip 90c is positioned adjacent to, and extends substantially parallel with, the second side edge 124, with at least a portion of the corresponding pull tab 94c extending outwardly from the first end edge 126. Finally, the fourth strip 90d is positioned adjacent to, and extends substantially parallel with, the second side edge 124, with at least a portion of the corresponding pull tab 94d extending outwardly from the second end edge 128.

In one embodiment, the strips 90a-90d are formed to include a backing (such as the backing 100 of FIG. 3B), and thus can be provided to a user apart from the touch screen 32. To this end, the strips 90a-90d can further include release liners (not shown) initially encompassing the respective adhesive compositions 106a, 106b (FIG. 3B). With this embodiment, then, the user removes one of the release liners from each of the strips 90a-90d to expose a corresponding adhesive composition 106a or 106b for subsequent adhering to the second major face 82. In an alternative embodiment, the strips 90a-90d are formed without a backing, such that the strips 90a-90d are coated or otherwise formed on to the touch screen 32, with the resultant touch screen assembly system being provided to a user (for example, with a release liner encompassing the “exposed” adhesive composition opposite the second major face 82). Further, and as will be described in greater detail below, the number and arrangement of the strips 90a-90d are but one example of an acceptable method in accordance with principles of the present invention.

Once the strips 90a-90d have been adhered to the touch screen 32, the touch screen assembly 24 is mounted to the display assembly 22 (FIG. 1). For example, the connective circuitry 34 is electronically coupled to the computer 30 (FIG. 1) in a manner known in the art. The touch screen 32 is placed over the display panel assembly 28 (FIG. 1). It will be recalled that the display panel assembly 28 typically includes the display panel 40 (FIG. 1) and the frame 42 (FIG. 1). With this in mind, the touch screen 32 can be arranged such that the adhered strips 90a-90d are aligned with either of the display panel 40 or the frame 42, although in one preferred embodiment, the strips 90a-90d are aligned with the frame 42 so as to not overtly obscure image(s) subsequently displayed on the display panel 40. Regardless, the touch screen 32 is then pressed against the display panel assembly 28 so as to adhere the strips 90a-90d to the display panel assembly 28, thus attaching the touch screen 32 to the display panel assembly 28.

FIG. 4B illustrates a relationship between the strip 90a, the touch screen 32 and the display panel assembly 28 (for example the frame 42) upon final mounting. A thickness of the strip 90a is exaggerated in the view of FIG. 4B for purposes of clarity. The strip 90a is adhered to each of the touch screen 32 and the display panel assembly 28 via the adhesive segment 92a (referenced generally), thereby mounting the touch screen 32 to the display panel assembly 28. Further, the pull tab 94a extends outwardly from the first end edge 126 of the display screen 32. With this relationship, the pull tab 94a is readily available for grasping by a user (not shown). Thus, to detach the touch screen 32 from the display panel assembly 28, a user need only remove the strip 94a via a stretch removing operation whereby the user applies a longitudinal pulling force on to the pull tab 94a. More particularly, and with reference to FIG. 4C, a puling force (F) is applied to the pull tab 94a in a direction substantially parallel to the surface of the touch screen 32 and the surface of the display panel assembly 28 to which the strip 94a is applied. The bonded structure of the strip 90a exhibits a relatively high initial resistance to shearing stress. When sufficient force is applied to overcome this resistance, the backing 100 begins to deform; the backing 100 thus yields while the adhesive 106a, 106b elongates and releases from the touch screen 32 and the display panel assembly 28. This process is repeated for each of the remaining strips 90b-90d (FIG. 4A). Notably, and unlike conventional touch screen/display panel assembly removal techniques, the operator is not required to cut the strips 90a-90d with a cutting tool, and thus potential harm to the operator and/or the display panel assembly 28 is avoided. Once all of the strips 90a-90d have been removed, the touch screen 32 is readily lifted away from the display panel assembly 28.

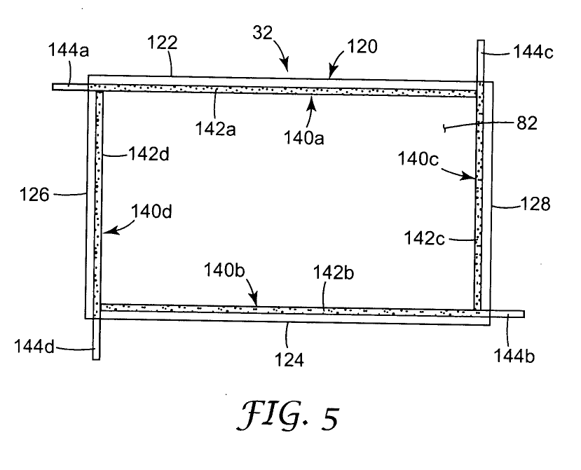

The strip 90a-90d arrangement provided in FIG. 4A is but one acceptable technique. For example, fewer than four of the strips 90 can be utilized (including use of only a single strip 90); conversely, more that four strips 90 can be employed. Further, one or more of the strips 90a-90d can have lengths differing from that schematically represented FIG. 4A. For example, FIG. 5 illustrates partial assembly of the touch screen 32 to the display panel assembly 28 (FIG. 1) in accordance with another embodiment of the present invention. Once again, the second major face 82 of the touch screen 32 is shown in FIG. 5. Typically, the perimeter 120 of the touch screen 32 is rectangular, such that a length of the side edges 122, 124 is greater than a length of the end edges 126, 128. With these conventions in mind, the mounting technique associated with FIG. 5 includes providing first and second double-sided, stretch releasable adhesive strips 140a, 140b, and third and fourth double-sided, stretch releasable adhesive strips 140c, 140d. The strips 140a-140d have a general construction identical to that previously described with respect to the strip 90 (FIGS. 3A and 3B). However, the first and second strips 140a, 140b have a length approximating a length of the side edges 122, 124, whereas the third and fourth strips 140c, 140d have a length approximating a length of the end edges 126, 128. For example, the strips 140a-140d can be initially provided to the user as cut to the desired length. Alternatively, each of the strips 140a-140d can have an elongated length (i.e., longer than the expected lengths of the edges 122-128); with this embodiment, the user first cuts the strips 140a-140d to a desired length after examining (e.g., measuring) the lengths of the edges 122-128.

Regardless, an adhesive segment 142a of the first strip 140a is adhered to the second major face 82, positioned adjacent to and extending substantially parallel with, the first side edge 122. The first strip 140a is sized to encompass a majority, preferably approximately an entirety of, the first side edge 122. Further, at least a portion of a non-tacky pull tab 144a of the first strip 140a extends outwardly from the first end edge 126, and thus from the perimeter 120. An adhesive segment 142c of the third strip 140c is adhered to the second major face 82, positioned adjacent to and extending substantially parallel with, the second end edge 128. A pull tab 144c of the third strip 140c extends outwardly from the first side edge 122. As shown in FIG. 5, the third strip 140c contacts the first strip 140a. An adhesive segment 142b of the second strip 140b is adhered to the second major face 82, positioned adjacent to and extending substantially parallel with, the second side edge 124. A pull tab 144b of the second strip 140b extends outwardly from the second end edge 128. As shown in FIG. 5, the second strip 140b contacts the third strip 140c. An adhesive segment 142d of the fourth strip 140d is adhered to the second major face 82, positioned adjacent to and extending substantially parallel with, the first end edge 126. A pull tab 144d of the fourth strip 140d extends outwardly from the second side edge 124. As shown in FIG. 5, the fourth strip 140d contacts the first strip 140a and the second strip 140b. The touch screen 32 is then removably mounted to the display panel assembly 28 (FIG. 1) via the strips 140a-140d as previously described. With this technique, the strips 140a-140d combine to define a dust seal between the touch screen 32 and the display panel assembly 28, and are easily removed from the touch screen 32 and the display panel assembly 28 via a stretch release operation (it being understood that the respective pull tabs 144a-144d are readily available for grasping by a user in performing a stretch release operation).

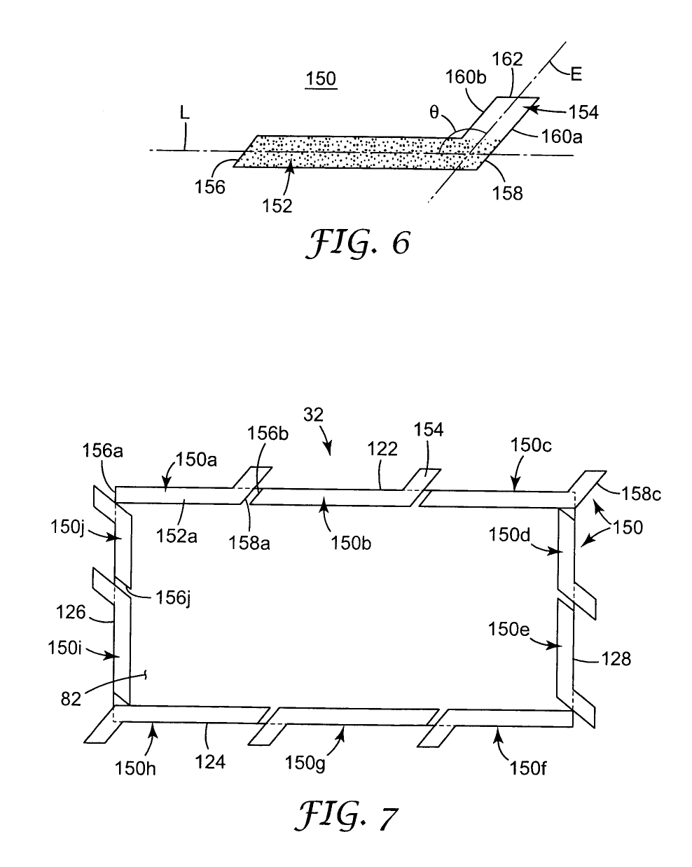

While the double-sided, stretch releasable adhesive strips 90 (FIG. 3A), 140 have been illustrated as forming the pull tab (such as the pull tab 94 of FIG. 3A) as extending is a co-linear fashion from the adhesive segment (such as the adhesive segment 92 of FIG. 3A), alternative configurations are also envisioned. For example, FIG. 6 illustrates a preferred alternative embodiment double-sided, stretch releasable adhesive strip 150 in accordance with principles of the present invention. The strip 150 has a general construction identical to that previously described with respect to the strip 90 (FIG. 3A), and thus includes an adhesive segment 152 and a non-tacky pull tab segment 154. The adhesive segment 152 and the pull tab 154 can be formed in accordance with any of the embodiments previously described (e.g., can be formed as a stand alone strip or as a strip coated on (or otherwise formed on) the touch screen 32 (FIG. 1)). However, unlike previous embodiments, the pull tab 154 extends from the adhesive segment 152 in an angular fashion. More particularly, the adhesive segment 152 defines a leading end 156 and a trailing end 158, extending linearly to define the longitudinal axis L. The pull tab 154 extends from the trailing end 158 to define the extension axis E. As shown in FIG. 6, angular extension of the pull tab 154 relative to the adhesive segment 152 results in the longitudinal and extension axes L, E combining to define an extension angle θ that is less than 180°. The leading end 156 is formed, in one embodiment, to define an angular orientation commensurate with extension of the pull tab 154 relative to the adhesive segment 152 (e.g., the leading end 156 is oriented to be parallel with the extension axis E). Alternatively, the leading end 156 can have a variety of other constructions, such as a squared-off configuration (e.g., perpendicular to the longitudinal axis L), curved, etc.

In one embodiment, the extension angle θ is less than 170°; greater than 90°; preferably in the range of 91°-179°; more preferably in the range of 110°-160°. As described in greater detail below, this angular relationship suggests to a user a proper pull force direction for performing a stretch release operation. That is to say, stretch release of the strip 150 occurs in a manner essentially identical to that previously described with respect to the strip 90 (FIG. 3A), whereby the pull tab 154 is grasped and pulled in a direction opposite the leading end 156, substantially parallel with the longitudinal axis L. Along these same lines, in one embodiment the pull tab 154 is shaped so as to further suggest a proper pull force direction, such as by forming opposing sides 160a, 160b thereof to be parallel with each other and the extension axis E, and a terminating end 162 thereof to be parallel with the longitudinal axis L. Regardless, by forming the strip 150 such that the pull tab 154 extends in an angular manner relative to the adhesive segment 152, the strip 150 is more universally useful with a variety of differently-sized touch screens 32 (FIG. 1).

For example, FIG. 7 schematically illustrates partial mounting of the touch screen 32 to the display panel assembly 28 (FIG. 1) pursuant to an alternative method in accordance with principles of the present invention, using a plurality of the strips 150 (referenced generally). Relative to the first side edge 122 of the second major face 82, first-third strips 150a-150c are adhered. More particularly, the adhesive segment 152a of the first strip 150a is adhered to the face 82 adjacent to, and extending substantially parallel with, the first side edge 122. At least a portion of the pull tab 154a extends outwardly from the first side edge 122. The second and third strips 150b, 150c are similarly arranged in an end-to-end manner as shown. Additional ones of the strips 150d-150j are adhered in a like manner relative to the second side edge 124 and the end edges 126, 128, effectively providing a dust barrier or seal for the touch screen 32 upon mounting to the display panel assembly 28 (FIG. 1). Upon subsequent assembly to the display assembly 22 (including, for example, electronically coupling connective circuitry (not shown) otherwise associate with the touch screen 32 to the computer 30 (FIG. 1)), the strips 150 serve to removably mount the touch screen 32 to the display panel assembly 28 as previously described. The touch screen 32 can subsequently be detached from the display panel assembly 28 by performing a stretch release operation upon each of the strips 150.

Notably, the above configuration of the strip 150 facilitates placement of three or more of the strips 150 along a length of the side or end edges 122-128 as the pull tab projects outwardly from the edge 122-128 to which the strip 150 is applied. In other words, with a more conventional stretch release adhesive strip in which the pull tab is co-linear with the longitudinal axis defined by the adhesive segment, at most only two of such strips can be applied relative to a particular edge 122-128; the pull tab of any “intermediate” strip would not project beyond the perimeter of the touch screen 32, and thus could not be easily located/grasped by a user. With the strip 150, however, the pull tab 154 associated with the intermediate strips (such as the strip 150b of FIG. 7) projects outwardly from the perimeter and can thus easily by located and grasped by a user to perform a stretch release operation.

In one embodiment, a plurality of the strips 150 is provided to a user (not shown) in multiple different lengths so that the user can pick and choose an appropriate combination for substantially encompassing the length of the edge 122-128 in question. In another embodiment, a plurality of the strips 150 are again provided; however, each of the strips 150 has an identical length (e.g., on the order of 6-10 inches). As a point of reference, each of the respective adhesive segments 152 can also have an identical width, for example on the order of 0.25-0.375 inch. Regardless, with this embodiment, the method of mounting the touch screen 32 to the display panel assembly 28 further includes the user determining a length of the edge 122-128 in question, comparing this determined length to the length of the strips 150, and then, based upon this comparison, cutting one of the strips 150 to an appropriate size.

For example, relative to the first side edge 122 (and with an embodiment whereby the strips 150a-150j are initially provided with identical lengths), the user first determines the length of the edge 122. The length is compared to the length of the strips 150; based upon this comparison, a determination is made that a sum of the lengths of three of the strips 150 slightly exceeds the length of the edge 122. Based upon this comparison, the second and third strips 150b, 150c are applied to the second major face 82, adjacent the first side edge 122, as shown. Prior to applying the first strip 150a, the first strip 150a is cut to a length commensurate with the remaining, un-encompassed length of the first side edge 122. More particularly, the adhesive segment 152a is cut at a point opposite the trailing end 158a such that the first strip 150a now has an appropriate length. The cut effectively defines a “new” leading end 156a for the adhesive segment 152a. As shown, the cut leading end 156a can have a squared-off shape so as to more closely match the first side edge 126 (as opposed, for example, to the angled leading end 156b of the second strip 150b). Alternatively, differently-shaped/oriented cuts can be made. For example, the strip 150j has been cut such the cut leading end 156j has an angled orientation. Once cut, the first strip 150a is adhered to the touch screen 32 as shown. A similar process can be repeated for each of the remaining edges 124-128. Thus, by providing a plurality of identically sized ones of the strips 150, virtually any dimensioned touch screen can be accommodated. Further, by proper arrangement, the plurality of strips 150 can perform or provide a sealing function between the touch screen 32 and the display panel assembly 28 (FIG. 1) upon final mounting. In this regard, the corresponding angular orientations defined by the leading end 156 (FIG. 6) and the pull tab 154 in accordance with one embodiment allows adjacent strips 150 to be closely positioned relative to one another when placed end-to-end (e.g., the end-to-end relationship of the strips 150a-150c illustrated in FIG. 7).

The double-sided, stretch releasable adhesive strip(s) 90 (FIG. 3A), 150 can be provided with the touch screen assembly 24 (FIG. 1)/touch screen 32 as part of a touch screen assembly system. To this end, the touch screen assembly system can entail the strip(s) 90 or 150 being provided apart from the touch screen 32 for subsequently adhering thereto by the user (e.g., where the strip(s) 90 or 150 includes the backing 100 (FIG. 3B)). Alternatively, the touch screen assembly system can be characterized by the strip(s) 90 or 150 being pre-applied (e.g., coated) to the touch screen 32 prior to delivery to a user.

Similarly, the double-sided stretch releasable adhesive strips 90 (FIG. 3A) or 150 can be provided as part of a kit for mounting a glass substrate-based touch screen to a display panel assembly. The kit includes a plurality of the strips 90 and/or 150, along with, in some embodiments, an instruction manual outlining instructions on how to use the plurality of strips 90 and/or 150 to releasably mount a touch screen to a display panel assembly, such as the steps previously described.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof. For example, while the methods described (and related double-sided, stretch releasable adhesive strips) have been in connection with removably mounting a touch screen to a display panel assembly as part of assembling a touch screen display assembly, the methodologies (and strips) are also applicable to a variety of other applications generally entailing removably mounting a glass substrate-based object to the surface of a second object (e.g., mounting vandal-proof glass or privacy glass to a display, bezel or chassis).

What is claimed is:

1. A method of removably mounting a touch screen assembly, including a glass substrate-based touch screen, to a display panel assembly of a touch screen display system, the method comprising:
providing at least a first double-sided, stretch releasable adhesive strip; and
adhering the strip to the touch screen and the display panel assembly to attach the touch screen to the display panel;
wherein the strip is configured to be releasable from the touch screen and the display panel assembly via a stretch release operation to facilitate removal of the touch screen from the display panel assembly.

2. The method of claim 1, wherein the touch screen forms a major surface defining a perimeter having opposing side edges and opposing end edges, and further wherein adhering the strip to the touch screen includes:
extending the strip along at least a portion of the major surface such that a segment of the strip projects outwardly beyond the perimeter.

3. The method of claim 2, wherein the strip includes an adhesive segment and a non-tacky pull tab segment, and further wherein extending the strip is characterized by the pull tab projecting outwardly beyond the perimeter.

4. The method of claim 3, further comprising removing the touch screen from the display panel assembly, including:
applying a pulling force on to the pull tab at a pull angle of not more than 45° to cause the strip to stretch release from the touch screen and the display panel assembly; and
lifting the display screen from the display panel assembly.

5. The method of claim 3, wherein the pull tab extends from the adhesive segment in a co-linear fashion relative to a longitudinal axis defined by the adhesive segment, and further wherein extending the strip includes:
positioning the strip adjacent to and substantially parallel with a first one of the side edges such that the pull tab projects outwardly from a corresponding one of the end edges.

6. The method of claim 3, wherein the pull tab extends from the adhesive segment in an angular fashion relative to a longitudinal axis defined by the adhesive segment, and further wherein extending the strip includes:
positioning the strip adjacent to and substantially parallel with a first one of the side edges such that the pull tab projects outwardly from the first side edge.

7. The method of claim 6, wherein positioning the strip is characterized by the pull tab being laterally spaced from the both of the opposing end edges.

8. The method of claim 6, further comprising:
providing a second double-sided, stretch releasable adhesive strip including an adhesive segment and a non-tacky pull tab segment extending in an angular fashion from the adhesive segment of the second strip in an angular fashion relative to a longitudinal axis thereof; and
positioning the second strip adjacent to and substantially parallel with the first side edge such that the first and second strip are arranged in an end-to-end manner.

9. The method of claim 2, wherein the first strip is positioned adjacent to and substantially parallel with a first side edge of the touch screen, the method further comprising:
extending a second double-sided, stretch releasable adhesive strip along the major face of the touch screen adjacent to and substantially parallel with a second side edge;
extending a third double-sided, stretch releasable adhesive strip along the major face of the touch screen adjacent to and substantially parallel with a first end edge; and
extending a fourth double-sided, stretch releasable adhesive strip along the major face of the touch screen adjacent to and substantially parallel with a second end edge.

10. The method of claim 1, further comprising:
providing a plurality of double-sided, stretch releasable adhesive strips; and
attaching the touch screen to the display panel assembly with the plurality of strips;
wherein the plurality of strips are positioned to establish a dust barrier relative to a perimeter of the touch screen.

11. The method of claim 10, wherein each of the plurality of strips includes an adhesive segment and a non-tacky pull tab segment, and further wherein the plurality of strips are positioned such that each of the respective pull tabs extends outwardly from the perimeter.

12. The method of claim 1, wherein the touch screen includes a major face having a perimeter edge defining a length, and further wherein providing at least a first strip includes providing a plurality of strips of identical length that is less that the length of the perimeter edge, the method further comprising:
determining a difference between a sum of the lengths of the plurality of strips and the length of the perimeter edge;
cutting the first strip to a reduced length based upon the determination; and
applying the plurality of strips in a end-to-end fashion adjacent to and substantially parallel with the perimeter edge such that the plurality of strips combine to substantially encompass the perimeter edge.

13. The method of claim 12, wherein each of the plurality of strips includes an adhesive segment, defining a leading end and a trailing end, and a non-tacky pull tab segment extending from the trailing end in an angular fashion relative to a longitudinal axis defined by the corresponding adhesive segment, and further wherein cutting the first strip includes:
cutting the adhesive segment along a longitudinal length thereof at a point opposite the trailing edge.

14. The method of claim 13, wherein applying the plurality of strips is characterized by each of the respective pull tabs extending outwardly from the perimeter edge.

15. The method of claim 1, wherein the touch screen assembly includes connective circuitry extending from the touch screen, and the display system includes a computer, the method further comprising:
electronically coupling the connective circuitry to the computer.

16. The method of claim 1, wherein the first strip exhibits a 180° peel strength on a glass substrate at 98% relative humidity of at least about 5.47 N/dm.

17. The method of claim 1, wherein adhering the first strip to the touch screen and the display panel assembly is characterized by the first strip remaining adhered to the touch screen and the display panel assembly at temperatures in the range of −40° C. to 60° C.

18. The method of claim 17, wherein adhering the first strip to the touch screen and the display panel assembly is further characterized by the first strip remaining adhered to the touch screen and the display panel assembly at 90% relative humidity.

19. The method of claim 1, wherein the display panel assembly includes a display panel and an outer frame, and further wherein the first strip is disposed between the touch screen and the outer frame.

20. A touch screen system for use as part of a touch screen display system including a display assembly, the touch screen system comprising:
a touch screen assembly including:
a glass substrate-based touch screen,
connective circuitry extending from the touch screen; and
a double-sided, stretch releasable adhesive strip configured to removably attach the touch screen to a display assembly.

21. The touch screen system of claim 20, further comprising:
a plurality of double-sided, stretch releasable adhesive strips.

22. The touch screen system of claim 20, wherein the strip includes an adhesive segment and a non-tacky pull tab segment extending from the adhesive segment in an angular fashion relative to a longitudinal axis defined by the adhesive segment.

23. The touch screen system of claim 20, wherein the strip includes a backing layer coated on opposing faces thereof with an adhesive composition such that the strip is provided apart from the touch screen for subsequent assembly thereto.

24. The touch screen system of claim 20, wherein the strip includes an adhesive composition and is characterized by the absence of a backing layer such that the strip is coated on to the touch screen.

25. A kit for removably mounting a glass substrate-based touch screen, to a display panel assembly, the kit comprising:
a plurality of double-sided, stretch releasable adhesive strips.

26. The kit of claim 25, further comprising:
an instruction manual outlining instructions on how to use the plurality of strips to removably mount a touch screen to a display panel assembly.

27. The kit of claim 25, wherein the plurality of strips each include an adhesive segment and a non-tacky pull tab segment extending from the adhesive segment in an angular fashion relative to a longitudinal axis defined by the adhesive segment.

28. A double-sided, stretch releasable adhesive strip for mounting a first, glass substrate-based object to a surface of a second object, the strip including an adhesive segment and a non-tacky pull tab segment extending from the adhesive segment in an angular fashion relative to a longitudinal axis defined by the adhesive segment.

29. The strip of claim 28, wherein extension of the pull tab defines an extension axis, and further wherein the extension axis and the longitudinal axis combine to define an extension angle of less than 170°.

30. The strip of claim 29, wherein the extension angle is greater than 90°.

31. The strip of claim 28, wherein the pull tab is shaped to visually indicate a desired pull direction for performing a stretch release operation.
